(19) United States
(12) Patent Application Publication
(10) Pub. No.: US 2004/0114731 A1
(43) Pub. Date: Jun. 17, 2004

(54) Communication system

(76) Inventors: Benjamin James Gillett, Ealing Green (GB); Charles Stephen Wiles, Ealing Green (GB); Mark Jonathan Williams, Ealingen Green (GB); Gary Michael Sleet, Ealing Green (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/451,396

(22) PCT Filed: Dec. 21, 2001
(86) PCT No.: PCT/GB01/05719

(30) Foreign Application Priority Data
Dec. 22, 2000 (GB) 0031511.9
Jul. 20, 2001 (GB) 0117770.8
Aug. 10, 2001 (GB) 0119598.3

(51) Int. Cl. H04M 1/64; H04M 7/00

(52) U.S. Cl. 379/88.03; 379/219

(57) ABSTRACT

A telephone system is described in which subscriber telephones store appearance models for the appearance of a party to the telephone call, from which it synthesises a video sequence of that party from a set of appearance parameters received from the telephone network. The appearance parameters may be generated either from a camera associated with the user's phone or may be generated from text or speech signals input by that party.

The present invention relates to a video processing method and apparatus. The invention has particular, although not exclusive, relevance to video telephony, video conferencing and the like using land line or mobile communication devices.

Existing video telephony systems suffer from a problem of limited bandwidth being available between the communications network (for example the telephone network or the internet) and the user's telephone. As a result, existing video telephone systems use efficient coding techniques (such as MPEG) to reduce the amount of video image data which is transmitted. However, the compressed image data is still relatively large and therefore still requires, for real time video telephony applications, a relatively large bandwidth between the user's terminal and the network.

The present invention aims to provide an alternative video communication system.

According to one aspect, the present invention provides a telephone which can generate an animated sequence by multiplying a set of appearance parameters out into shape and texture parameters using a stored appearance model, morphing the texture parameters together to generate a texture, morphing the shape parameters together to generate a shape and warping the texture to the image using the shape. By repeatedly carrying out these steps for received sets of parameters, an animated video sequence can be regenerated and displayed to a user on a display of the phone. In a preferred embodiment, the separate parameters are used to model different parts of the face. This is useful since the texture for most of the face does not change from frame to frame. On low powered devices, the texture does not need to be calculated every frame and can be recalculated every second or third frame or it can be recalculated when the texture parameters change by more than a predetermined amount.

Various other features and aspects of the invention will be appreciated by the following description of exemplary embodiments which are described with reference to the accompanying drawings in which:

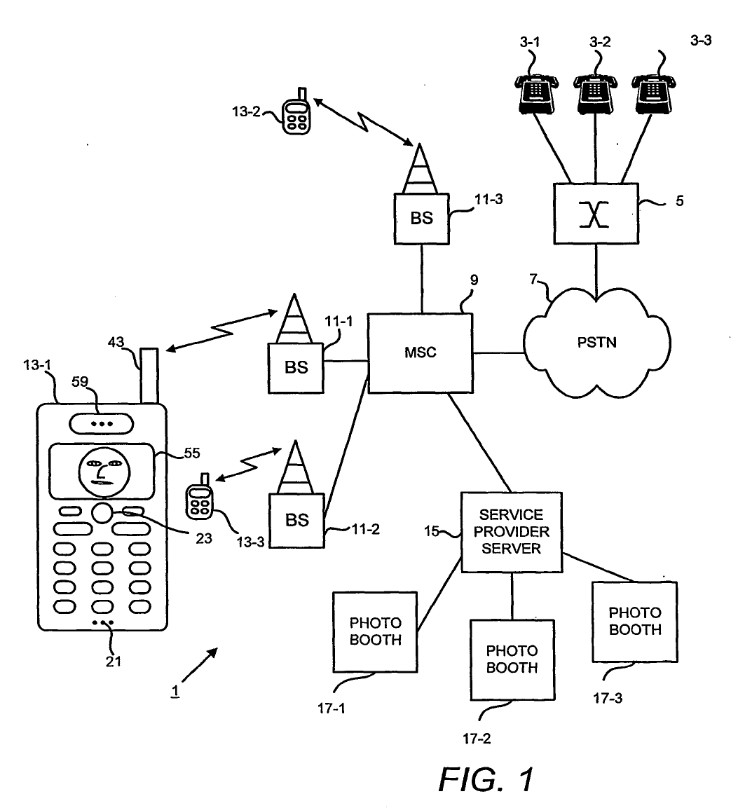

FIG. 1 is a schematic diagram of a telecommunication system;

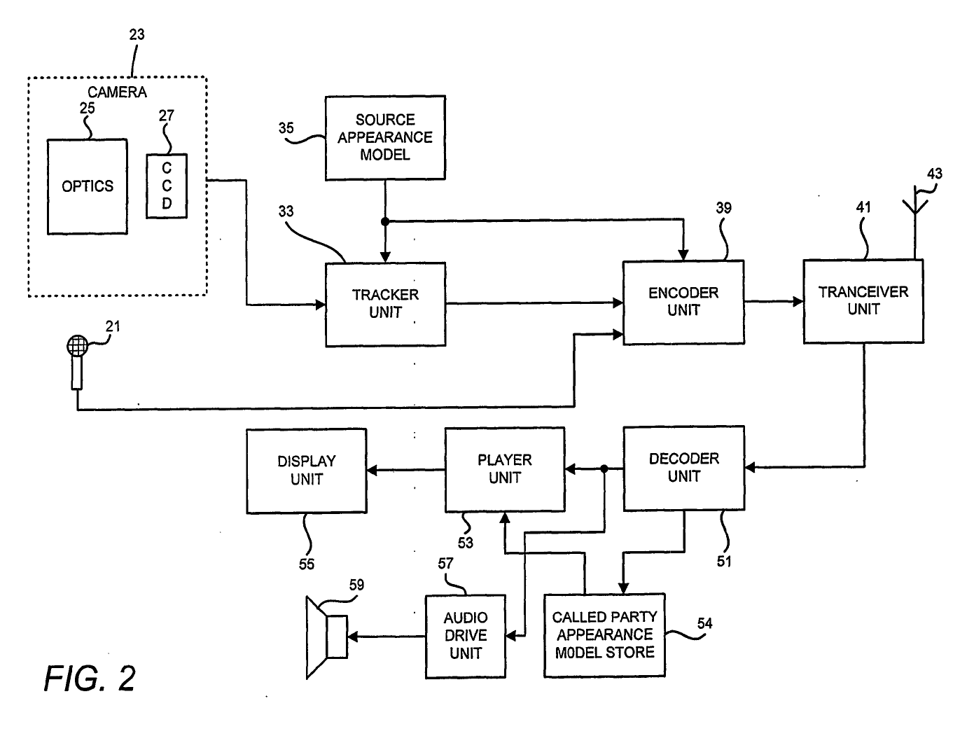

FIG. 2 is a schematic block diagram of a mobile telephone which forms part of the system shown in FIG. 1;

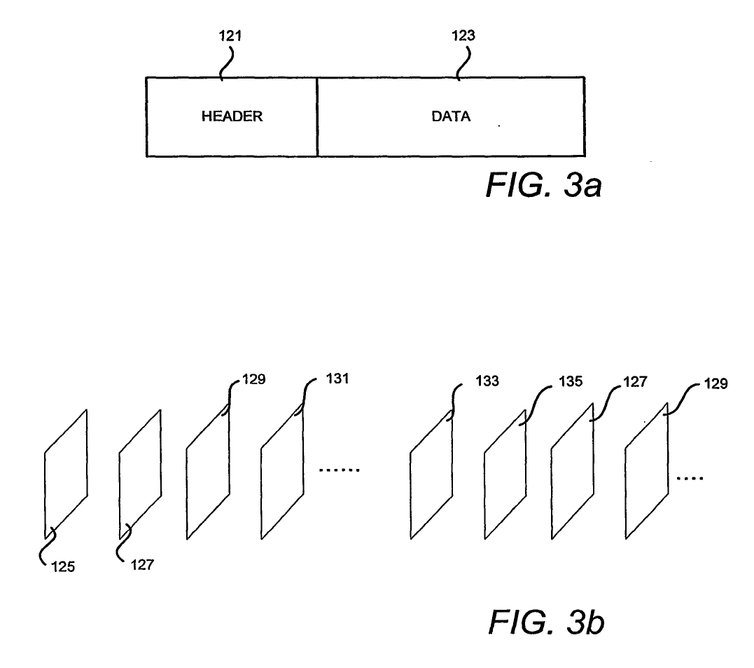

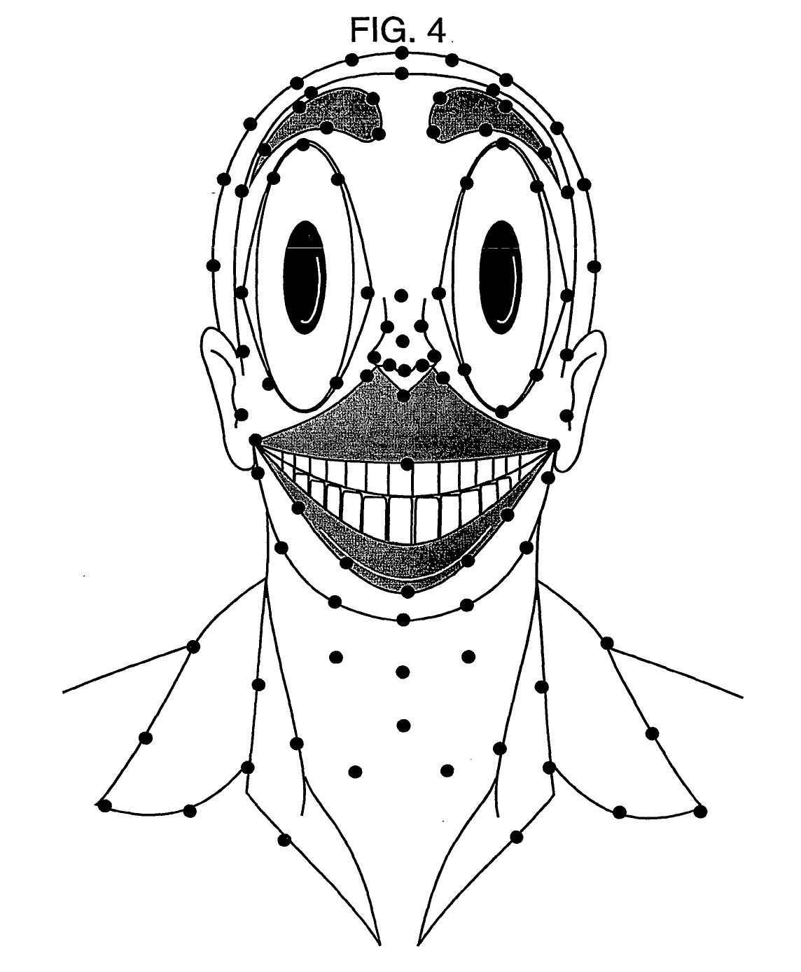

FIG. 3a is a schematic diagram illustrating the form of a data packet transmitted by the mobile telephone shown in FIG. 2;

FIG. 3b schematically illustrates a stream of data packets transmitted by the mobile telephone shown in FIG. 2;

FIG. 4 is a schematic illustration of a reference shape into which training images are warped before pixel sampling;

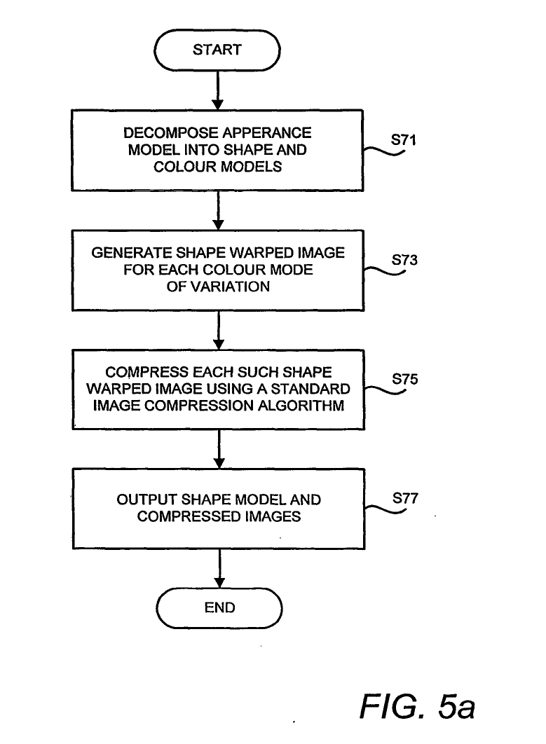

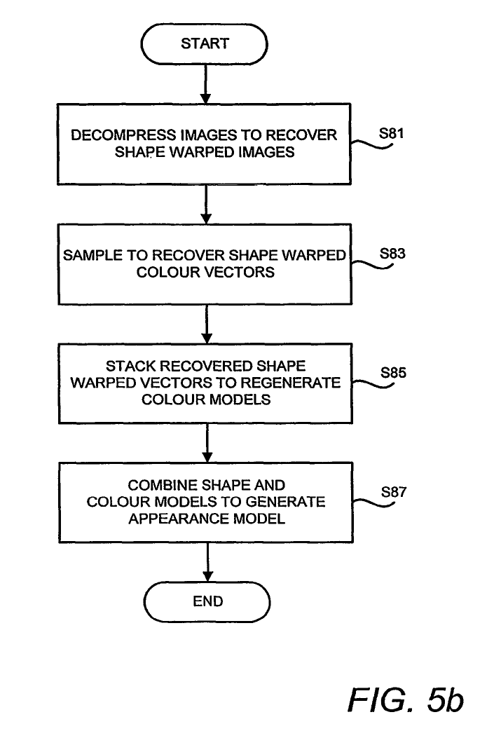

FIG. 5a is a flow chart illustrating the processing steps performed by an encoder unit which forms part of the telephone shown in FIG. 2;

FIG. 5b illustrates the processing steps performed by a decoding unit which forms part of the telephone shown in FIG. 2;

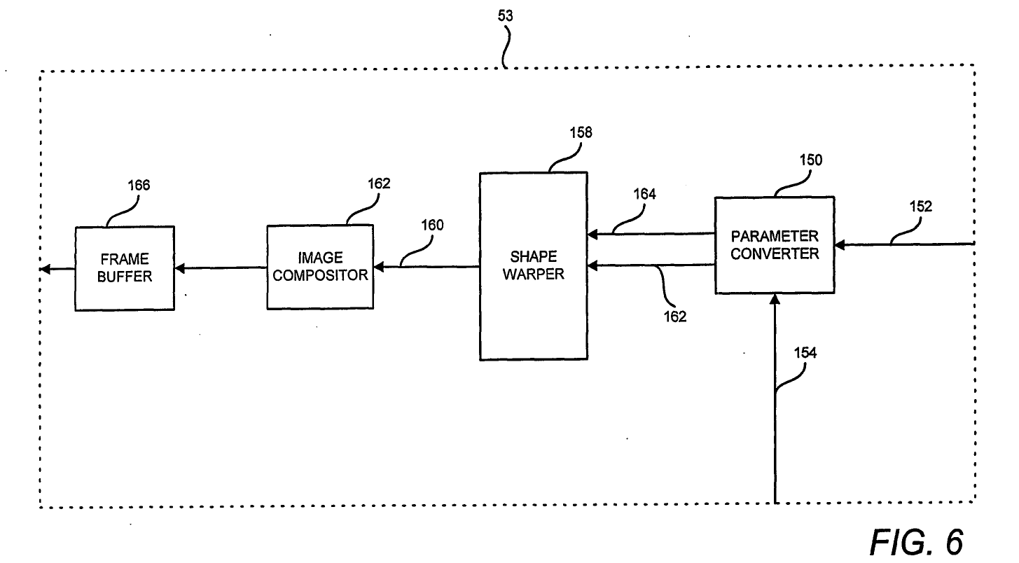

FIG. 6 is a schematic block diagram illustrating the main component of a player unit which forms part of the telephone shown in FIG. 2;

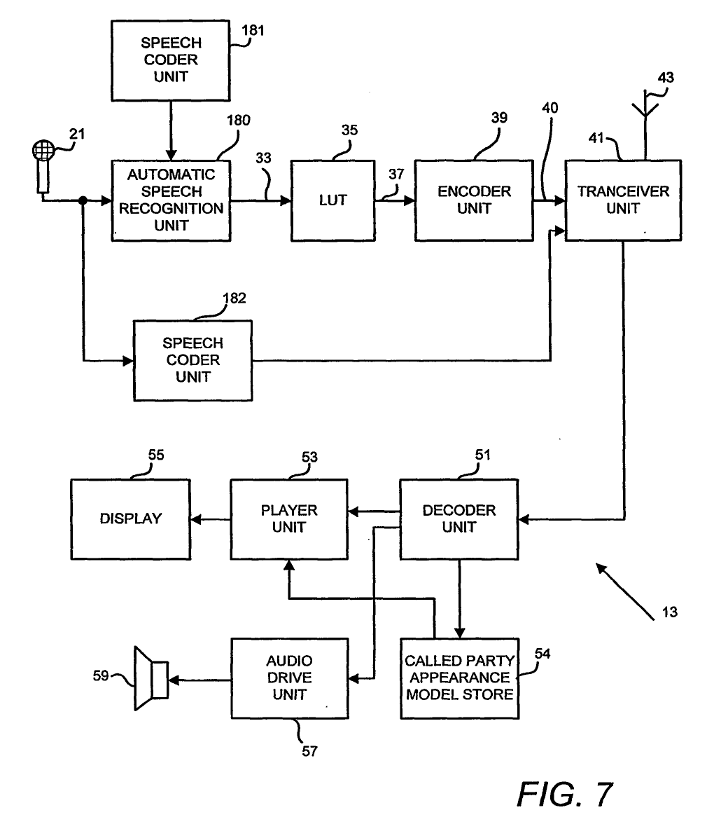

FIG. 7 is a block schematic diagram illustrating the form of an alternative mobile telephone which can be used in the system shown in FIG. 1;

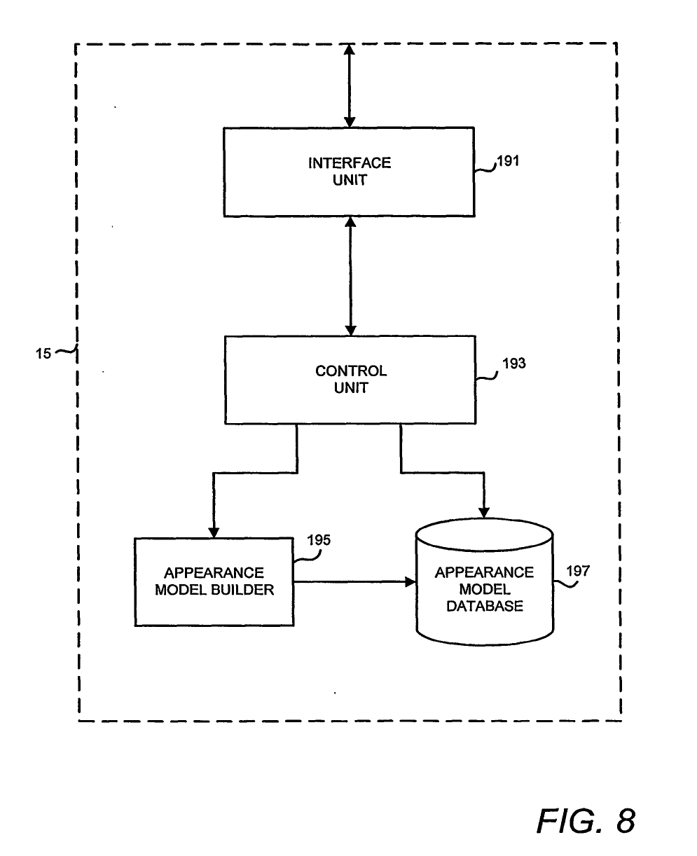

FIG. 8 is a block diagram illustrating the main components of a service provider server which forms part of the system shown in FIG. 1 and which interacts with the telephone shown in FIG. 7;

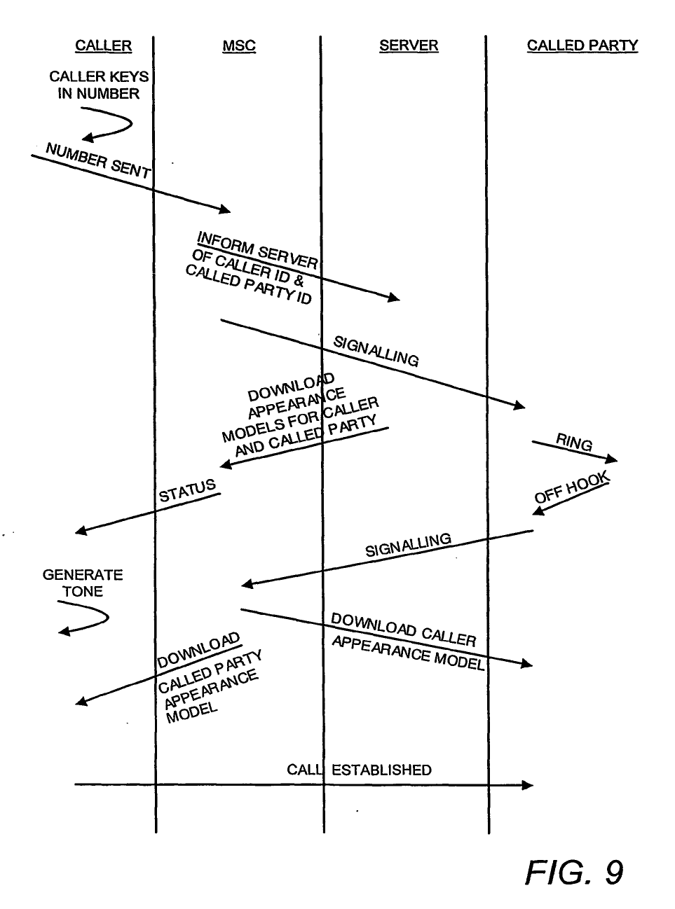

FIG. 9 is a control timing diagram illustrating the protocol used during the connection of a call between a caller and a called party using the telephone illustrated in FIG. 7;

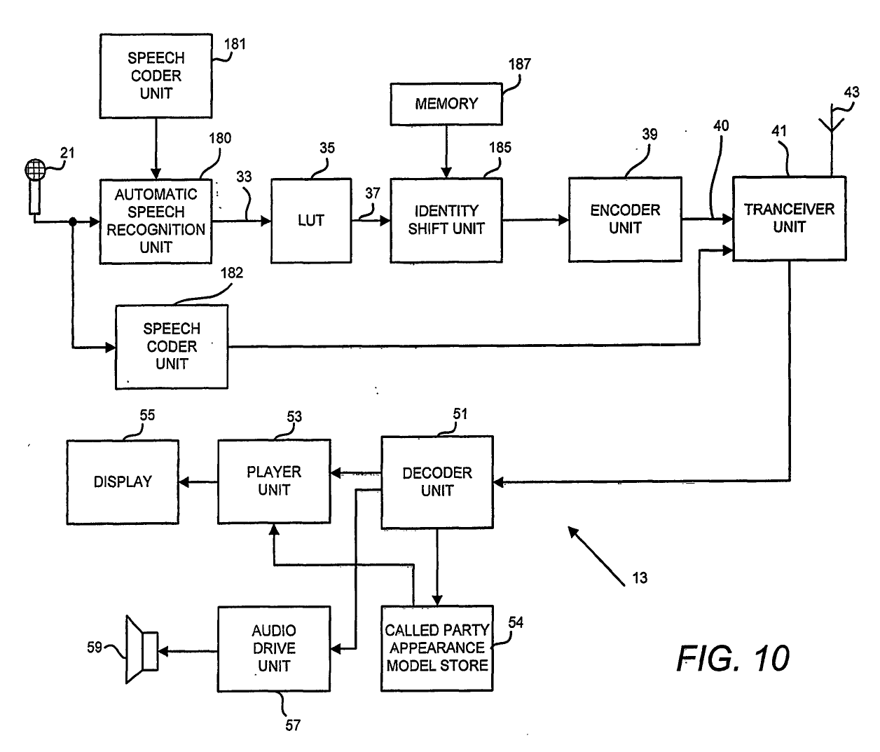

FIG. 10 is a schematic block diagram illustrating the main components of a mobile telephone according to an alternative embodiment;

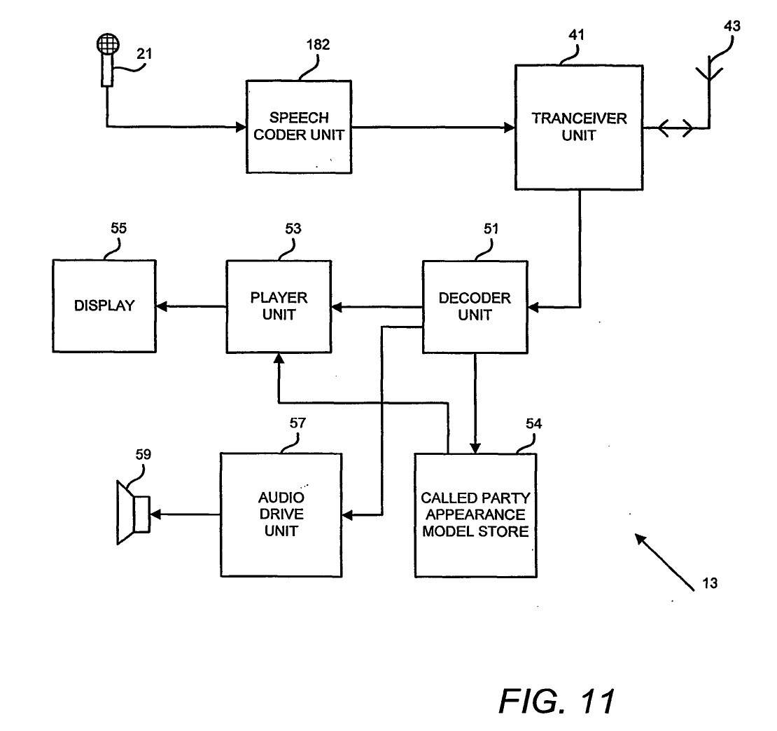

FIG. 11 is a schematic block diagram illustrating the main components of a mobile telephone according to a further embodiment;

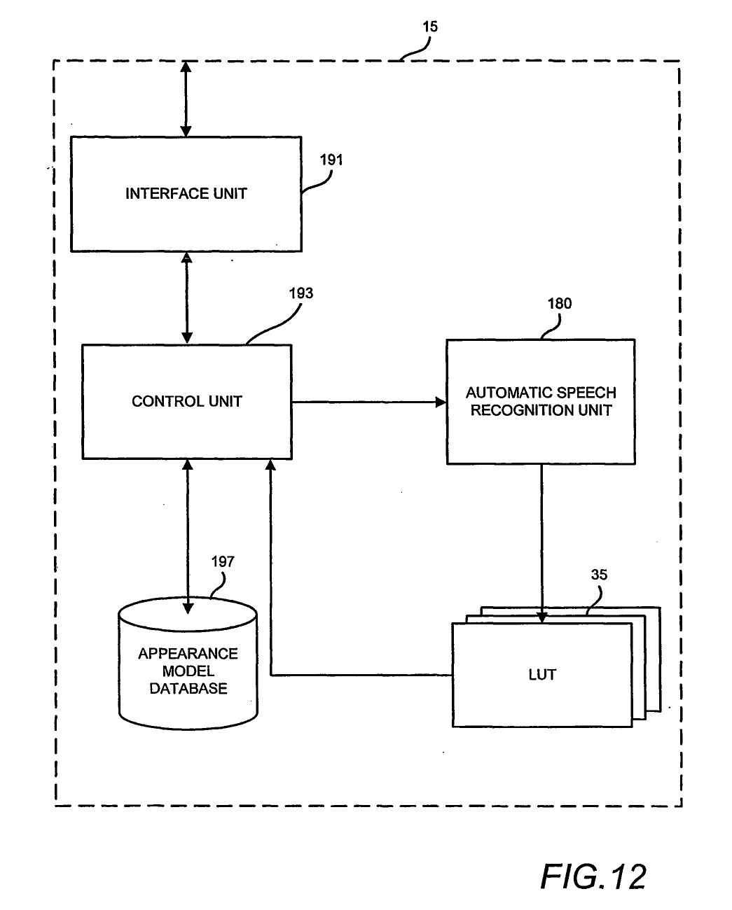

FIG. 12 is a schematic block diagram illustrating the main components of the service provider server used in an alternative embodiment;

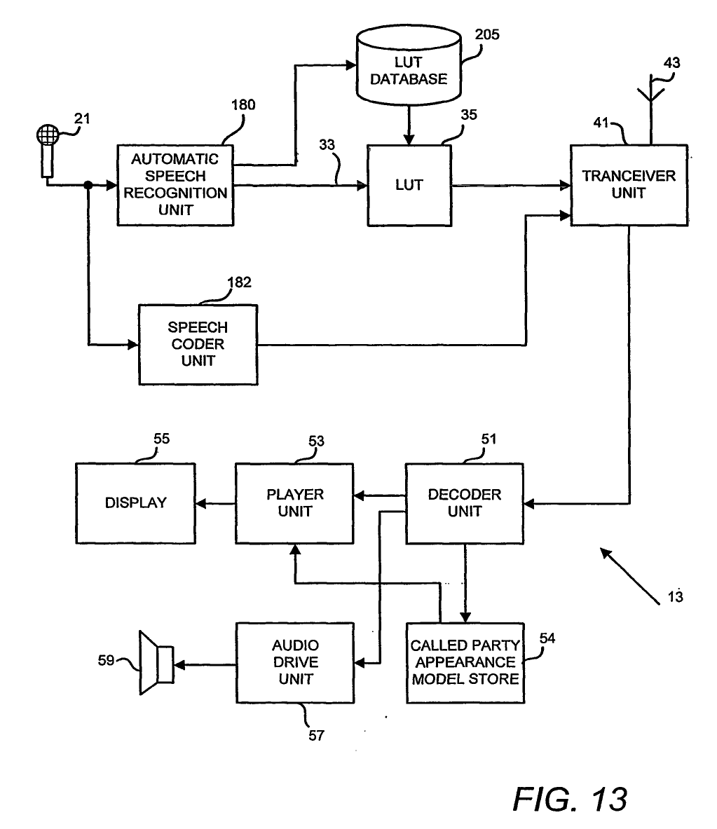

FIG. 13 is a schematic block diagram illustrating the main components of a mobile telephone according to a further embodiment;

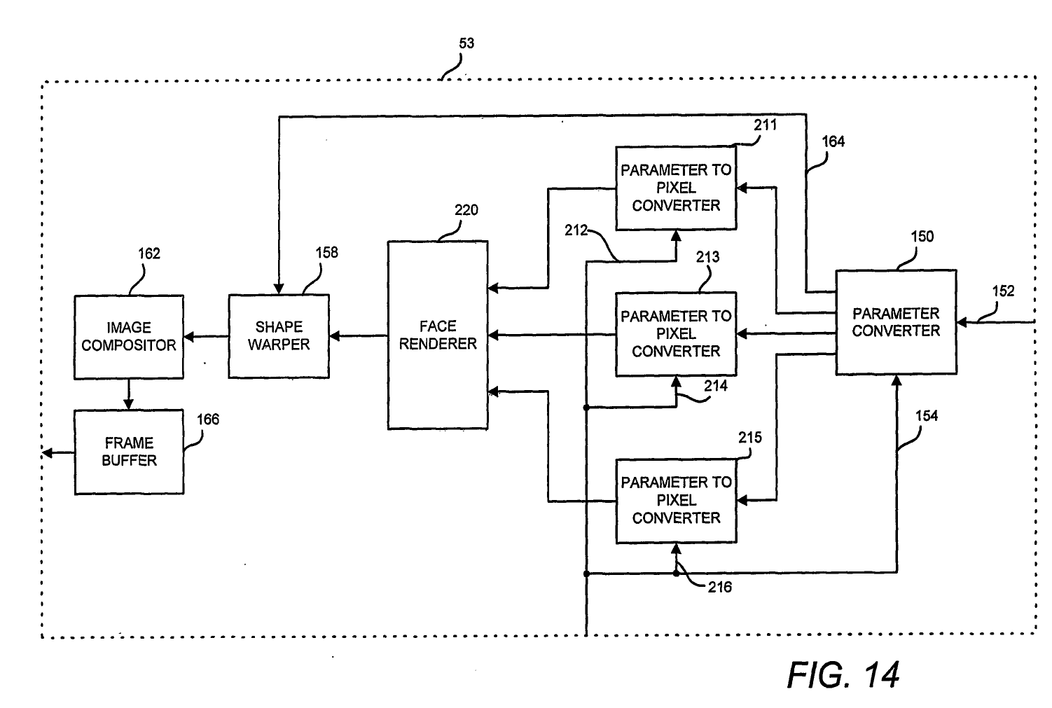

FIG. 14 is a schematic block diagram illustrating an alternative form of the player unit;

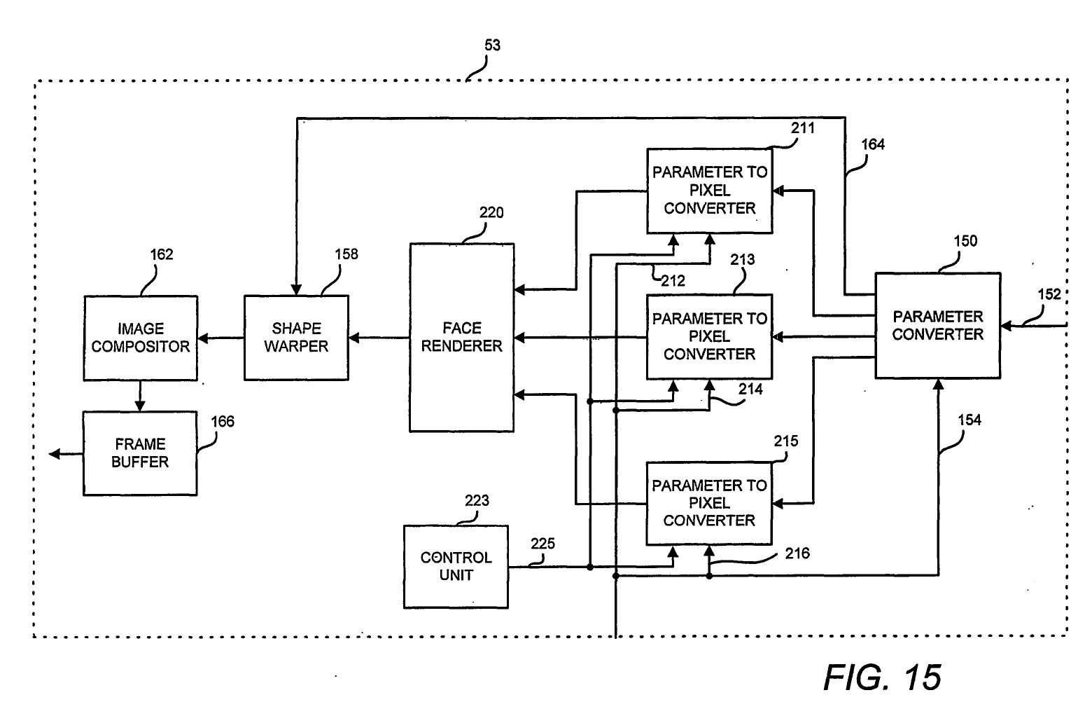

FIG. 15 is a schematic block diagram illustrating the main components of another alternative player unit; and

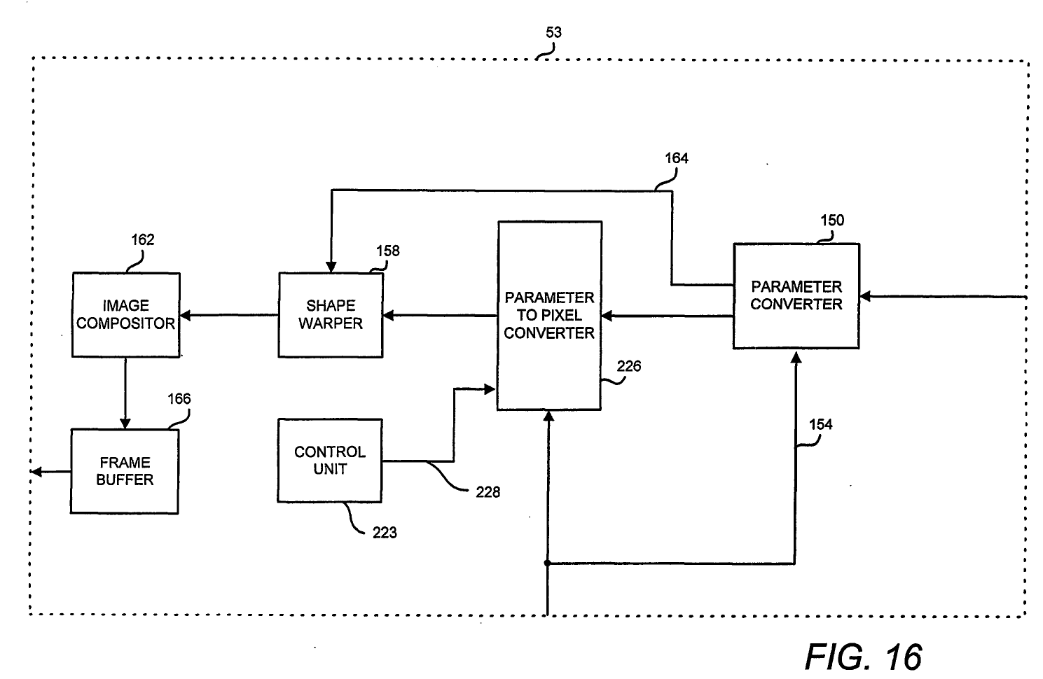

FIG. 16 is a schematic block diagram illustrating the main components of a further alternative player unit.

### OVERVIEW

FIG. 1 schematically illustrates a telephone network 1 which comprises a number of user landline telephones 3-1, 3-2 and 3-3 which are connected, via a local exchange 5 to the public switched telephone network (PSTN) 7. Also connected to the PSTN 7 is a mobile switching centre (MSC) 9 which is linked to a number of base stations 11-1, 11-2 and 11-3. The base stations 11 are operable to receive and transmit communications to a number of mobile telephones 13-1, 13-2 and 13-3 and the mobile switching centre 9 is operable to control connections between the base stations 11 and between the base stations 11 and the PSTN 7. As shown in FIG. 1, the mobile switching centre 9 is also connected to a service provider server 15 which, in this embodiment, generates appearance models for mobile phone subscribers. These appearance models model the appearance of the subscribers or the appearance of a character that the subscriber wishes to use. Where the appearance models model the appearance of the subscriber, digital images of the subscriber must be provided to the service provider server 15 so that the appropriate appearance model can be generated. In this embodiment, these digital photographs can be generated from any one of a number of photo booths 17 which are geographically distributed about the country.

A brief description of the way in which a video telephone call may be made using one of the subscriber mobile telephones 13-1 will now be given. In this embodiment, when a caller initiates a call using a subscriber telephone 13-1, the voice call is set up in the usual way via the base station 11-1 and the mobile switching centre 9. In this embodiment, the subscriber mobile telephone 13 includes a video camera 23 for generating a video image of the user. In this embodiment, however, the video images generated from camera 23 are not transmitted to the base station. Instead, the mobile telephone 13 uses the user's appearance model to parameterise the video images to generate a sequence of appearance parameters which are transmitted, together with the appearance model and the audio, to the base station 11. This data is then routed through the telephone network in the conventional way to the called party's telephone, where the video images are resynthesised using the parameters and the appearance model. Similarly, the appearance model for the called party together with the sequence of appearance parameters generated by the called party is transmitted over the telephone network to the subscriber telephone 13-1 where a similar process is performed to resynthesise the video image of the called party.

The way in which this is achieved in this embodiment will now be described in more detail with reference to FIGS. 2 to 5 for an example call between mobile telephone 13-1 and mobile telephone 13-2. FIG. 2 is a schematic block diagram of each of the mobile telephones 13 shown in FIG. 1. As shown, the telephone 13 includes a microphone 21 for receiving the user's speech and for converting it into a corresponding electrical signal.

The mobile telephone 13 also includes a video camera 23 which comprises optics 25 which focus light from the user onto a CCD chip 27 which in turn generates the corresponding video signals in the usual way. As shown, the video signals are passed to a tracker unit 33 which processes each frame of the video sequence in turn in order to track the facial movements of the user within the video sequence. To perform this tracking, the tracker unit 33 uses an appearance model which models the variability of the shape and texture of the user's face. This appearance model is stored in the user appearance model store 35 and is generated by the service provider server 15 and downloaded into the mobile telephone 13-1 when the user first subscribes to the system. In tracking the user's facial movements in the video sequence, the tracker unit 33 generates, for each frame, pose and appearance parameters which represent the appearance of the user's face in the current frame. The generated pose and appearance parameters are then input to an encoder unit 39 together with the audio signals output from the microphone 21.

In this embodiment, however, before the encoder unit 39 encodes the pose and appearance parameters and the audio, it encodes the user's appearance model for transmission to the called party's mobile telephone 13-2 via the transceiver unit 41 and the antenna 43. This encoded version of the user's appearance model may be stored for subsequent transmission in other video calls. The encoder unit 39 then encodes the sequence of pose and appearance parameters and encodes the corresponding audio signals which it transmits to the called party's mobile telephone 13-2. In this embodiment, the audio signals are encoded using a CELP encoding technique and the encoded CELP parameters are transmitted in an interleaved manner with the encoded pose and appearance parameters.

As shown in FIG. 2, data received from the called party mobile telephone 13-2 is passed from the transceiver unit 41 to a decoder unit 51 which decodes the transmitted data. Initially, the decoder unit 51 will receive and decode the called party's appearance model which it then stores in the called party appearance model store 54. Once this has been received and decoded, the decoder unit 51 will receive and decode the encoded pose and appearance parameters and the encoded audio signals. The decoded pose and appearance parameters are then passed to a player unit 53 which generates a sequence of video frames corresponding to the sequence of received pose and appearance parameters using the decoded called party's appearance model. The generated-video frames are then output to the mobile telephone's display 55 where the regenerated video sequence is displayed to the user. The decoded audio signals output by the decoder unit 51 are passed to an audio drive unit 57 which outputs the decoded audio signals to the mobile telephone's loud speaker 59. The operation of the player unit 53 and the audio drive unit 57 are arranged to that images displayed on the display 55 are time synchronised with the appropriate audio signals output by the loudspeaker 59.

In this embodiment, the mobile telephones 13 transmit the encoded pose and appearance parameters and the encoded audio signals in data packets. The general format of the packets is shown in FIG. 3a. As shown, each packet includes a header portion 121 and a data portion 123. The header portion 121 identifies the size and type of the packet. This makes the data format easily extendible in a forwards and backwards compatible way. For example, if an old player unit 53 is used on a new data stream, it may encounter packets that it does not recognise. In this case, the old player can simply ignore those packets and still have a chance of processing the other packets. The header 121 in each packet includes 16 bits (bit 0 to bit 15) for identifying the size of the packet. If bit 15 is set to 0, the size defined by the other 15 bits is the size of the packets in bytes. If, on the other hand, bit 15 is set to one, then the remaining bits represent the size of the packet in 32 k blocks. In this embodiment, the encoder unit 39 can generate six different types of packets (illustrated in FIG. 3b). These include:

1. Version packet 125—the first packet sent in a steam is the version packets. The number defined in the version packet is an integer and is currently set at the number 3. This number is not expected to change due to the extendible nature of the packet system.

2. Information packet 127—the next packet to be transmitted is an information packet which includes a sync byte: a byte identifying the average samples (or frames) per second of video; data identifying the number of shorts of parameter data for animating each sample of video short; a byte identifying the number of audio samples per second; a byte identifying the number of bytes of data per sample of audio and a bit identifying whether or not the audio is compressed. Currently, this bit is set at 0 for uncompressed audio and 1 for audio compressed at 4800 bits per second.

3. Audio packet 129—for uncompressed audio, each packet contains one second worth of audio data. For 4800 bits per second compressed audio, each packet contains 30 milliseconds worth of data, which is 18 bytes.

4. Video packet 131—appearance parameter data for animating a single sample of video.

5. Super-audio packet 133—this is a concatenated set of data for normal audio packets 129. In this embodiment, the player unit 53 determines the number of audio packets in the super audio packet by its size.

6. Super-video packet 135—this is a concatenated set of data from normal video packets 131. In this embodiment, the player unit 53 determines the number of video packets by the size of the super-video packet.

In this embodiment, the transmitted audio and video packets are mixed into the transmitted stream in time order, with the earliest packets being transmitted first. Organising the packet structure in the above way also allows the packets to be routed over the Internet in addition to through the PSTN 7.

Appearance Models

The appearance models used in this embodiment are similar to those developed by Cootes et al and described in, for example, the paper entitled “Active Shape Models—Their Training and Application”, Computer Vision and Image Understanding, Vol. 61, No. 1, January, pages 38 to 59, 1995. These appearance models make use of the fact that some prior knowledge is available about the contents of face images. For example, it can be assumed that two frontal images of a human face will each include eyes, a nose and a mouth.

As mentioned above, in this embodiment, the appearance models are generated in the service provider server 15. These appearance models are generated by analysing a number of training images of the respective user. In order that the user appearance model can model the variability of the user's face within a video sequence, the training images should include images of the user having the greatest variation in facial expression and 3D pose. In this embodiment, these training images are generated by the user going into one of the photo booths 17 and being filmed by a digital camera.

In this embodiment, all the training images are colour images having 500 by 500 pixels, with each pixel having a red, green and blue pixel value. The resulting appearance models 35 are a parameterisation of the appearance of the class of head images defined by the heads in the training images, so that a relatively small number of parameters (typically 15 to 40 for a single person) can describe the detail (pixel level) appearance of a head image from the class.

As explained in the applicant's earlier International Application WO 00/17820 (the contents of which are incorporated herein by reference), the appearance model is generated by initially determining a shape model which models the variability of the face shapes within the training images and a texture model which models the variability of the texture or colour of the pixels in the training images, and by then combining the shape model and the texture model.

In order to create the shape model, the position of a number of landmark points are identified on a training image and then the position of the same landmark points are identified on the other training images. The result of this location of the landmark points is a table of landmark points for each training image, which identifies the (x, y) coordinates of each landmark point within the image. The modelling technique used in this embodiment then examines the statistics of these coordinates over the training set in order to determine how these locations vary within the training images. In order to be able to compare equivalent points from different images, the heads must be aligned with respect to a common set of axes. This is achieved by iteratively rotating, scaling and translating the set of coordinates for each head so that they all approximately fill the same reference frame. The resulting set of coordinates for each head form a shape vector (xⁱ) whose elements correspond to the coordinates of the landmark points within the reference frame. In this embodiment, the shape model is then generated by performing a principal component analysis (PCA) on the set of shape training vectors (xⁱ). This principal component analysis generates a shape model (Qₛ) which relates each shape vector (xⁱ) to a corresponding vector of shape parameters (pₛⁱ), by:

pₛⁱ=Qₛ(xⁱ−\overline{x}) (1)

where xⁱ is a shape vector, \overline{x} is the mean shape vector from the shape training vectors and pⁱₛ is a vector of shape parameters for the shape vector xⁱ. The matrix Qₛ describes the main modes of variation of the shape and pose within the training heads; and the vector of shape parameters (pₛⁱ) for a given input head has a parameter associated with each mode of variation whose value relates the shape of the given input head to the corresponding mode of variation. For example, if the training images include images of the user looking left and right and looking straight ahead, then one mode of variation which will be described by the shape model (Qₛ) will have an associated parameter within the vector of shape parameters (pₛ) which affects, among other things, where the user is looking. In particular, this parameter might vary from −1 to +1, with parameter values near −1 being associated with the user looking to the left, with parameters values around 0 being associated with the user looking straight ahead and with parameter values near +1 being associated with the user looking to the right. Therefore, the more modes of variation which are required to explain the variation within the training data, the more shape parameters are required within the shape parameter vector pₛⁱ. In this embodiment, for the particular training images used, twenty different modes of variation of the shape and pose must be modelled in order to explain 98% of the variation which is observed within the training heads.

In addition to being able to determine a set of shape parameters pₛⁱ for a given shape vector xⁱ, equation (1) can be solved with respect to xⁱ to give:

xⁱ=\overline{x}+Qₛ^{T}pₛⁱ (2)

since QₛQₛ^{T} equals the identity matrix. Therefore, by modifying the set of shape parameters (pₛⁱ), within suitable limits, new head shapes can be generated which will be similar to those in the training set.

Once the shape model has been generated, similar models are generated to model the texture within the training faces, and in particular the red, green and blue levels within the training faces. To do this, in this embodiment, each training face is deformed into a reference shape. In the applicant's earlier International application, the reference shape was the mean shape. However, this results in a constant resolution of pixel sampling across all facets in the training faces. Therefore, a facet corresponding to part of the cheek, that has ten times the area of a facet on the lip, will have ten times as many pixels sampled. As a result, this cheek facet will contribute ten times as much to the texture models which is undesirable. Therefore, in this embodiment, the reference shape is deformed by making the facets around the eyes and mouth larger than in the mean shape so that the eye and mouth regions are sampled more densely than the other parts of the face. In this embodiment, this is achieved by warping each training image head until the position of the landmark points of each image coincide with the position of the corresponding landmark points depicting the shape and pose of the reference head (which are determined in advance). The colour values in these shape warped images are used as input vectors to the texture model. The reference shape used in this embodiment and the position of the landmark points on the reference shape are schematically shown in FIG. 4. As can be seen from FIG. 4, the size of the eyes and mouth in the reference shape have been exaggerated compared to the rest of the features in the face. As a result, when the shape warped training images are sampled, more pixel samples are taken around the eyes and mouth compared to the other features in the face. This results in texture models which are more responsive to variations in and around the mouth and eyes and hence are better for tracking the user in the source video sequence. Various triangulation techniques can be used to deform each training head to the reference shape. One such technique is described in the applicant's earlier International application discussed above.

Once the training heads have been deformed to the reference shape, red, green and blue level vectors (rⁱ, gⁱ and bⁱ) are determined for each shape warped training face, by sampling the respective colour level at, for example, ten thousand evenly distributed points over the shape warped heads. A principal component analysis of the red level vectors generates a red level model (matrix Qᵣ) which relates each red level vector to a corresponding vector of red level parameters by:

pᵣⁱ=Qᵣ(rⁱ−\overline{r}) (3)

where rⁱ is the red level vector, \overline{r} is the mean red level vector from the red level training vectors and pⁱᵣ is a vector of red level parameters for the red level vector rⁱ. A similar principal component analysis of the green and blue level vectors yields similar models:

p_{g}ⁱ=Q_{g}(gⁱ−\overline{g}) (4)

p_{b}ⁱ=Q_{b}(bⁱ−\overline{b}) (5)

These colour models describe the main modes of variation of the colour within the shape-normalised training faces.

In the same way that equation (1) was solved with respect to xⁱ, equations (3) to (5) can be solved with respect to rⁱ, gⁱ and bⁱ to give:

$$\begin{matrix}{r}^{i} = \overline{r} + {Q}_{r}^{T} {p}_{r}^{i} \\ {g}^{i} = \overline{g} + {Q}_{g}^{T} {p}_{g}^{i} \\ {b}^{i} = \overline{b} + {Q}_{b}^{T} {p}_{b}^{i} & ( 6 )\end{matrix}$$

since QᵣQᵣ^{T}, Q_{g}Q_{g}^{T} and Q_{b}Q_{b}^{T} are identity matrices. Therefore, by modifying the set of colour parameters (pᵣ, p_{g} or p_{b}), within suitable limits, new shape warped colour faces can be generated which will be similar to those in the training set.

As mentioned above, the shape model and the colour models are used to generate an appearance model (Fₐ) which collectively models the way in which both the shape and the colour varies within the faces of the training images. A combined appearance model is generated because there are correlations between the shape and the colour variation, which can be used to reduce the number of parameters required to describe the total variation within the training faces. In this embodiment, this is achieved by performing a further principal component analysis on the shape and the red, green and blue parameters for the training images. In particular, the shape parameters are concatenated together with the red, green and blue parameters for each of the training images and then a principal component analysis is performed on the concatenated vectors to determine the appearance model (matrix Fₐ) However, in this embodiment, before concatenating the shape parameters and the texture parameters together, the shape parameters are weighted so that the texture parameters do not dominate the principal component analysis. This is achieved by introducing a weighting matrix (Hₛ) into equation (2) such that:

xⁱ=\overline{x}+[Qₛ^{T}Hₛ⁻¹][Hₛpₛⁱ] (7)

where Hₛ is a multiple (λ) of the appropriately sized identity matrix, i.e:

$${H}_{s} = ( \begin{matrix}λ & 0 & 0 & … & 0 \\ 0 & λ & 0 & … & 0 \\ 0 & 0 & λ & … & 0 \\ ⋮ & ⋮ & ⋮ & ⋰ & \\ 0 & 0 & 0 & & λ\end{matrix} ) \qquad ( 8 )$$

where λ as a constant. The inventors have found that values of λ between 1,000 and 10,000 provide good results. Therefore, Qₛ^{Y} and pₛⁱ become:

\hat{Q}ₛ^{T}=Qₛ^{T}Hₛ⁻¹

\hat{p}ₛ ⁱ=Hₛpₛⁱ (9)

Once the shape parameters have been weighted, a principal component analysis is performed on the concatenated vectors of the modified shape parameters and the red, green and blue parameters for each of the training images, to determine the appearance model, such that:

$${p}_{a}^{i} = {F}_{a} [ \begin{matrix}{\hat{p}}_{s}^{i} \\ {p}_{r}^{i} \\ {p}_{g}^{i} \\ {p}_{b}^{i}\end{matrix} ] = {F}_{a} {p}_{sc}^{i} \qquad ( 10 )$$

where pⁱₐ is a vector of appearance parameters controlling both shape and colour and pⁱ_{sc} is the vector of concatenated modified shape and colour parameters.

Once the modified shape model ( Qₛ), the colour models (Qᵣ, Q_{g} and Q_{b}) and the appearance model (Fₐ) have been determined, they are transmitted to the user's mobile telephone 13 where they are stored for subsequent use.

In addition to being able to represent an input face by a set of appearance parameters (pₐⁱ), it is also possible to use those appearance parameters to regenerate the input face. In particular, by combining equation (10) with equations (1) and (3) to (5) above, expressions for the shape vector and for the RGB level vectors can be determined as follows:

xⁱ=\overline{x}+Vₛpₐⁱ (11)

rⁱ=\overline{r}+Vᵣpₐⁱ (12)

gⁱ=\overline{g}+V_{g}pₐⁱ (13)

bⁱ=\overline{b}+V_{b}pₐⁱ (14)

where Vₛ is obtained from Fₐ and Qₛ, Vᵣ is obtained from Fₐ and Qᵣ, V_{g} is obtained from Fₐ and Q_{g}, and V_{b} is obtained from Fₐ and Q_{b}. In order to regenerate the face, the shape warped colour image generated from the colour parameters must be warped from the reference shape to take into account the shape of the face as described by the shape vector xⁱ. The way in which the warping of a shape free grey level image is performed was described in the applicant's earlier International application discussed above. As those skilled in the art will appreciate, a similar processing technique is used to warp each of the shape warped colour components, which are then combined to regenerate the face image.

Encoder Unit

A description will now be given with reference to FIG. 5a of the preferred way in which the encoder unit 39 shown in FIG. 2 encodes the user's appearance model for transmission to the called party's mobile telephone 13-2. A description will then be given, with reference to FIG. 5b, of the way in which the decoder unit 51 regenerates the called party's appearance model (which is encoded in the same way).

Initially, in step s71, the encoder unit 39 decomposes the user's appearance model into the shape (Qₛ^{trgt}) and colour models (Qᵣ^{trgt}, Q_{g}^{trgt} and Q_{b}^{trgt}). Then, in step s73, the encoder unit 39 generates shape warped colour images for each red, green and blue mode of variation. In particular, shape warped red, green and blue images are generated using equations (6) above for each of the following vectors of colour parameters:

$${p}_{r}^{i} ; {p}_{g}^{i} ; {p}_{b}^{i} = ( \begin{matrix}1 \\ 0 \\ 0 \\ ⋮ \\ 0\end{matrix} ) ; ( \begin{matrix}0 \\ 1 \\ 0 \\ ⋮ \\ 0\end{matrix} ) ; ( \begin{matrix}0 \\ 0 \\ 1 \\ ⋮ \\ 0\end{matrix} ) ; ⋯ ( \begin{matrix}0 \\ 0 \\ 0 \\ ⋮ \\ 1\end{matrix} ) \qquad ( 15 )$$

(although the mean vectors used in equation (6) may be ignored if desired). These shape warped images and the mean colour images (\overline{r}, \overline{g} and \overline{b}) are then compressed, in step s75, using a standard image compression algorithm, such as JPEG. However, as those skilled in the art will appreciate, prior to compression using the JPEG algorithm, the shape warped images and the mean colour images must be composited into a rectangular reference frame, otherwise the JPEG algorithm will not work. Since all the shape normalised images have the same shape, they are composited into the same position in the rectangular reference frame. This position is determined by a template image which, in this embodiment is generated directly from the reference shape (schematically illustrated in FIG. 4), and which contains 1's and 0's, with the 1's in the template image corresponding to background pixels and the 0's in the template image corresponding to image pixels. This template image must also be transmitted to the called party's mobile telephone 13-2 and is compressed, in this embodiment, using a run-length encoding technique. The encoder unit 39 then outputs, in step s77, the shape model (Qₛ^{trgt}), the appearance model ((Fₐ^{trgt})^{T}), the mean shape vector (\overline{x}^{trgt}) and the thus compressed images for transmission to the telephone network via the transceiver unit 41.

Decoder Unit

Referring to FIG. 5b, the decoder unit 51 decompresses, in step s81, the JPEG images, the mean colour images and the compressed template image. The processing then proceeds to step s83 where the decompressed JPEG images are sampled to recover the shape warped colour vectors (rⁱ, gⁱ and bⁱ) using the decompressed template image to identify the pixels to be sampled. Because of the choice of the colour parameter vectors used to generate these shape warped colour images (see (15) above), the colour models (Qᵣ^{trgt}, Q_{g}^{trgt} and Q_{b}^{trgt}) can then be reconstructed by stacking the corresponding shape warped colour vectors together. As shown in FIG. 5b, this stacking of the shape free colour vectors is performed in step s85. The processing then proceeds to step s87 where the recovered shape and colour models are combined to regenerate the called party's appearance model which is stored in the store 54.

In this embodiment, with this preferred encoding technique, the colour models are transmitted to the other party approximately ten times more efficiently than they would if the colour models were simply transmitted on their own. This is because, each colour model used in this embodiment is typically a thirty thousand by eight matrix and each element of each matrix requires three bytes. Therefore, each mobile telephone 13 would have to transmit about 720 kilobytes of data to transmit the colour model matrixes in uncompressed form. Instead, by generating the shape warped colour images described above and encoding them using a standard image encoding technique and transmitting the encoded images, the amount of data required to transmit the colour models is only about 70 kilobytes.

Player Unit

FIG. 6 is a block diagram illustrating in more detail the components of the player unit 53 used in this embodiment. As shown, the player unit comprises a parameter converter 150 which receives the decoded appearance parameters on the input line 152 and the called party's appearance model on the input line 154. In this embodiment, the parameter converter 150 uses equations (11) to (14) to convert the input appearance parameters pₐⁱ into a corresponding shape vector xⁱ and shape warped RGB level vectors (rⁱ, gⁱ, bⁱ) using the called party's appearance model input on line 154. The RGB level vectors are output on line 156 to a shape warper 158 and the shape vector is output on line 164 to the shape warper 158. The shape warper 158 operates to warp the RGB level vectors from the reference shape to take into account the shape of the face as described by the shape vector xⁱ. The resulting RGB level vectors generated by the shape warper 158 are output on the output line 160 to an image compositor 162 which uses the RGB level vectors to generate a corresponding two dimensional array of pixel values which it outputs to the frame buffer 166 for display on the display 55.

Modifications and Alternative Embodiments

In the first embodiment described above, each of the subscriber telephones 13-1 included a camera 23 for generating a video sequence of the user. This video sequence was then transformed into a set of appearance parameters using a stored appearance model. A second embodiment will now be described in which the subscriber telephones 13 do not include a video camera. Instead, the telephones 13 generate the appearance parameters directly from the user's input speech. FIG. 7 is a block schematic diagram of a subscriber telephone 13. As shown, the speech signals output from the microphone 21 are input to an automatic speech recognition unit 180 and a separate speech coder unit 182. The speech coder unit 182 encodes the speech for transmission to the base station 121 via the transceiver unit 41 and the antenna 43, in the usual way. The speech recognition unit 180 compares the input speech with pre-stored phoneme models (stored in the phoneme model store 181) to generate a sequence of phonemes 33 which it outputs to a look up table 35. The look up table 35 stores, for each phoneme, a set of appearance parameters and is arranged so that for each phoneme output by the automatic speech recognition unit 180, a corresponding set of appearance parameters which represent the appearance of the user's face during the pronunciation of the corresponding phoneme are output. In this embodiment, the look up table 35 is specific to the user of the mobile telephone 13 and is generated in advance during a training routine in which the relationship between the phonemes and the appearance parameters which generates the required image of the user from the appearance model is learned. Table 1 below illustrates the form that the look up table 35 has in this embodiment.

TABLE 1

| | Parameter | | | | | | |
|---|---|---|---|---|---|---|---|
| Phoneme | P₁ | P₂ | P₃ | P₄ | P₅ | P₆ | . . . |
| /ah/ | 0.34 | 0.1 | −0.7 | 0.23 | −0.15 | 0.0 | . . . |
| /ax/ | 0.28 | 0.15 | −0.54 | 0.1 | 0.0 | −0.12 | . . . |
| /r/ | 0.48 | 0.33 | 0.11 | −0.7 | −0.21 | 0.32 | . . . |
| /p/ | −0.17 | −0.28 | 0.32 | 0.0 | −0.2 | −0.09 | . . . |
| /t/ | 0.41 | −0.15 | 0.19 | −0.47 | −0.3 | −0.04 | . . . |
| /s/ | −0.31 | 0.28 | −0.02 | 0.0 | −0.22 | 0.14 | . . . |
| /m/ | 0.02 | −0.08 | 0.13 | 0.2 | 0.03 | 0.18 | . . . |
| . | . | . | . | . | . | . | |
| . | . | . | . | . | . | . | |
| . | . | . | . | . | . | . | |

As shown in FIG. 7, the sets of appearance parameters 37 output by the look up table 35 are then input to the encoder unit 39 which encodes the appearance parameters for transmission to the called party. The encoded parameters 40 are then input to the transceiver unit 41 which transmits the encoded appearance parameters together with the corresponding encoded speech. As in the first embodiment, the transceiver 41 transmits the encoded speech and the encoded appearance parameters in a time interleaved manner so that it is easier for the called party's telephone to maintain synchronization between the synthesised video and the corresponding audio.

As shown in FIG. 7, the receiver side of the mobile telephone is the same as in the first embodiment and will not, therefore, be described again.

As those skilled in the art will appreciate from the above description, in this second embodiment, the user's mobile telephone 134 does not need to have the user's appearance model in order to generate the appearance parameters which it transmits. However, the called party will need to have the user's appearance model in order to synthesise the corresponding video sequence. Therefore, in this embodiment, the appearance models for all of the subscribers are stored centrally in the service provider server 15 and upon initiation of a call between subscribers, the service provider server 15 is operable to download the appropriate appearance models into the appropriate telephone.

FIG. 8 shows in more detail the contents of the service provider server 15. As shown, it includes an interface unit 191 which provides an interface between the mobile switching centre 9 and the photo booth 17 and a control unit 193 within the server 15. When the server receives images for a new subscriber, the control unit 193 passes the images to an appearance model builder 195 which builds an appropriate appearance model in the manner described in the first embodiment. The appearance model is then stored in the appearance model database 197. Subsequently, when a call is initiated between subscribers, the mobile switching centre 9 informs the server 15 of the identity of the caller and the called party. The control unit 193 then retrieves the appearance models for the caller and the called party from the appearance model database 197 and transmits these appearance models back to the mobile switching centre 9 through the interface unit 191. The mobile switching centre 9 then transmits the appropriate appearance model for the caller to the called party telephone and transmits the appearance model to the respective subscriber telephones.

The control timing of this embodiment will now be described with reference to FIG. 9. Initially, the caller keys in the number of the party to be called using the keyboard. Once the caller has entered all the numbers and presses the send key (not shown) on the telephone 13, the number is then transmitted over the air interface to the base station 11-1. The base station then forwards this number to the mobile switching centre 9 which transmits the ID of the caller and that of the called party to the service provider server 15 so that the appropriate appearance models can be retrieved. The mobile switching centre 9 then signals the called party through the appropriate connections in the telephone network in order to cause the called party's telephone 13-2 to ring. Whilst this is happening, the service provider server 15 downloads the appropriate appearance models for the caller and the called party to the mobile switching centre 9, where they are stored for subsequent downloading to the user telephones. Once the called party telephone rings the mobile switching centre 9 sends status information back to the calling party's telephone so that it can generate the appropriate ringing tone. Once the called party goes off hook, appropriate signalling information is transmitted to the telephone network back to the mobile switching centre 9. In response, the mobile switching centre 9 downloads the caller appearance model to the called the party and downloads the call d party's appearanc model to the caller. Once these models have been downloaded, the respective telephones decode the transmitted appearance parameters in the same way as in the first embodiment described above, to synthesise a video image of the corresponding user talking. This video call remains in place until either the caller or the called party ends the call.

The second embodiment described above has a number of advantages over the first embodiment. Firstly, the subscriber telephones do not need to have a built in or attached video camera. The appearance parameters are generated directly from the user's speech. Secondly, the appearance models for the caller and the called party are only transmitted over one constraining communications link. In particular, in the first embodiment, each appearance model was transmitted from the user's telephone to the telephone network and then from the telephone network to the other's telephone. Whilst the bandwidth available in the telephone network is relatively high, the bandwidth in the channel from the network to the telephones is more limited. Therefore, in this embodiment, since the appearance models are stored centrally in the telephone network, they only have to be transmitted over one limited bandwidth link. As those skilled in the art will appreciate, the first embodiment could be modified to operate in a similar way with the appearance models being stored in the telephone network.

In the above embodiments, appearance parameters for the user were generated and transmitted from the user's telephone to the called party's telephone where a video sequence was synthesised showing the user speaking. An embodiment will now be described with reference to FIG. 10 in which the telephones have substantially the same structure as in the second embodiment but with an additional identity shift unit 185 which is operable to transform the appearance parameter values in order to change the appearance of the user. The identity shift unit 185 performs the transformation using a predetermined transformation stored in the memory 187. the transformation can be used to change the appearance of the user or to simply improve the appearance of the user. It is possible to add an offset to the appearance parameters (or the shape or texture parameters) that will change the perceived emotional state of the user. For example, adding the vector of appearance parameters for a slight smile to all appearance parameters generated from the speech of a “neutral” animation will make the person look happy. Adding the vector for a frown will make them look angry. There are various ways in which the identity shift unit 185 can perform the identity shifting. One way is described in the applicant's earlier International application WO00/17820. An alternative technique is described in the applicant's co-pending British Application GB0031511.9. The rest of the telephone in this embodiment is the same as in the second embodiment and will not, therefore, be described again.

In the second and third embodiments described above, the telephones included an automatic speech recognition unit. An embodiment will now be described with reference to FIGS. 11 and 12 in which the automatic speech recognition unit is provided in the service provider server 15 rather than in the user's telephone. As shown in FIG. 11, the subscriber telephone 13 is much simpler than the subscriber telephone of the second embodiment shown in FIG. 7. As shown, the speech signal generated by the microphone 21 is input directly to the speech coder unit 182 which encodes the speech in a traditional way. The encoded speech is then transmitted to the service provider server 15 via the transceiver unit 41 and the antenna 43. In this embodiment, all of the speech signals from the caller and the called party are routed via the service provider server 15, a block diagram of which is shown in FIG. 12. As shown, in this embodiment, the server 15 includes the automatic speech recognition unit 180 and all of the user look up tables 35.

In operation, when a call is established between the caller and the called party, all of the encoded speech is routed to the other party via the server 15. The server passes the speech to the automatic speech recognition unit 180 which recognises the speech and the speaker and outputs the generated phonemes to the appropriate look up table 35. The corresponding appearance parameters are then extracted from that look up table and passed back to the control unit 193 for onward transmission together with the encoded audio to the other party, where the video sequence is synthesised as before.

As those skilled in the art will appreciate, this embodiment offers the advantage that the subscriber telephones do not have to have complex speech recognition units, since everything is done centrally within the service provider server 15. However, the disadvantage is that the automatic speech recognition unit 180 must be able to recognise the speech of all of the subscribers and it must be able to identify which subscriber said what so that the phonemes can be applied to the appropriate look up table.

In the second to fourth embodiments described above, a single look up table 35 was provided for each subscriber, which mapped phonemes generated by the subscriber to corresponding appearance parameter values. However, the relationship between the phonemes output by the speech recognition unit and the actual appearance parameter values changes depending on the emotional state of the user. FIG. 13 is a block diagram illustrating the components of an alternative subscriber telephone in which a look up table database 205 stores different look up tables 35 for different emotional states of the user. The look up table database 205 may include appropriate look up tables for when the user is happy, angry, exited, sad etc. In this embodiment, the user's current emotional state is determined by the automatic speech recognition unit 180 by detecting stress levels in the user's speech.

In response, the automatic speech recognition unit 180 outputs an appropriate instruction to the look up table database 205 to cause the appropriate look up table 35 to be used to convert the phoneme sequence output from the speech recognition unit 180 into corresponding appearance parameters. As those skilled in the art will appreciate, each of the look up tables in the look up table database 205 will have to be generated from training images of the user in each of those emotional states. Again, this is done is advance and the appropriate look up tables are generated in the service provider server 16 and then downloaded into the subscriber telephone. Alternatively, a “neutral” look up table may be used together with an identity shift unit which could then perform an appropriate identity shift in dependence upon the detected emotional state of the user.

In the first embodiment described above, a CELP audio codec was used to encode the user's audio. Such an encoder reduces the required bandwidth for the audio to about 4.8 kilobits per second (kbps). This provides 2.4 kbps of bandwidth for the appearance parameters if the mobile phone is to transmit the voice and video data over a standard GSM link which has a bandwidth of 7.2 kbps. Most existing GSM phones, however, do not use a CELP audio encoder. Instead, they use an audio codec that uses the full 7.2 kbps bandwidth. The above systems would therefore only be able to work in an existing GSM phone if the CELP audio codec is provided in software. However, this is not practical since most existing mobile telephones do not have the computational power to decode the audio data.

The above system can, however, be used on existing GSM telephones to transmit pre-recorded video sequences. This is possible, since silences occur during normal conversation during which the available bandwidth is not used. In particular, for a typical speaker between 15% and 30% of the time the bandwidth is completely unused due to small pauses between words or phrases. Therefore, video data can be transmitted with the audio in order to fully utilise the available bandwidth. If the receiver is to receive all of the video and audio data before resynchronising the video sequence, then the audio and video data can be transmitted over the GSM link in any order and in any sequence. Alternatively, for a more efficient implementation which will allow the playing of the video sequence as soon as possible, appropriately sized blocks of video data (such as the appearance parameters described above) can be transmitted before the corresponding audio data, so that the video can start playing as soon as the audio is received. Transmitting the video data before the corresponding audio is optimal in this case since the appearance parameter data uses a smaller amount of data per second than the audio data. Therefore, if to play a four second portion of video requires four seconds of transmission time for the audio and one second of transmission time for the video, then the total transmission time is five seconds and the video can start playing after one second. If the silences in the audio are long enough, then such a system can operate with only a relatively small amount of buffering required at the receiver to buffer the received video data which is transmitted before the audio. However, if the silences in the audio are not long enough to do this, then more of the video must be transmitted earlier resulting in the receiver having to buffer more of the video data. As those skilled in the art will appreciate, such embodiments will need to time stamp both the audio and video data so that they can be re-synchronised by the player unit at the receiver.

These pre-recorded video sequences may be generated and stored on a server from which the user can download the sequence to their phone for viewing and subsequent transmission to another user. If the video sequence is generated by the user with their phone, then the phone will also need to include the necessary processing circuitry to identify the pauses in the audio in order to identify the amount of video data that can be transmitted with the audio and appropriate processing circuitry for generating the video data and for mixing it with the audio data so that the GSM codec fully utilises the available bandwidth.

As an alternative to driving the video sequence directly from speech, the animated sequence may be generated directly from text. For example, the user may transmit text to a central server which then converts the text into appropriate appearance parameters and coded audio which it transmits to the called party's telephone together with an appropriate appearance model. A video sequence can then be generated in the manner described above. In such an embodiment, when the user subscribes to the service and uses one of the photo booths to provide the images for generating the appearance model, the user may also input some phrases through a microphone in the photo booth so that the server can generate an appropriate speech synthesiser for that user which it will subsequently use to synthesise speech from the user's input text. As an alternative to synthesising the speech and generating the appearance parameters in the server, this may be done directly in the user's telephone or in the called party's telephone. However, at present such an embodiment is not practical since text to video generation is computationally expensive and requires the called party to have a capable phone.

In the above embodiments, an appearance model which modelled the entire shape and colour of the user's face was described. In an alternative embodiment, separate appearance models or just separate colour models may be used for the eyes, mouth and the rest of the face region. Since separate models are used, different numbers of appearance parameters or different types of models can be used for the different elements. For example, the models for the eyes and mouth may include more parameters than the model for the rest of the face. Alternatively, the rest of the face may simply be modelled by a mean texture without any modes of variation. This is useful, since the texture for most of the face will not change significantly during the video call. This means that less data needs to be transmitted between the subscriber telephones.

FIG. 14 is a schematic block diagram of a player unit 53 used in an embodiment where separate colour models (but a common shape model) are provided for the eyes and mouth and the rest of the face. As shown, the player unit 53 is substantially the same as the player unit 53 of the first embodiment except that the parameter converter 150 is operable to receive the transmitted appearance parameters and to generate the shape vector xᵢ (which it outputs on line 164 to the shape warper 158) and to separate the colour parameters for the respective colour models. The colour parameters for the eyes are output to the parameter to pixel converter 211 which converts those parameter values into corresponding red, green and blue level vectors using the eye colour model provided or the input line 212. Similarly, the mouth colour parameters are output by the parameter converter 150 to the parameter to pixel converter 213 which converts the mouth parameters into corresponding red, green and blue level vectors for the mouth using the mouth colour model input on line 214. Finally, the appearance parameter or parameters for the rest of the face region are input to the parameter to pixel converter 215 where an appropriate red, green and blue level vector is generated using the model input on line 216. As shown in FIG. 14, the RGB level vectors output from each of the parameter to pixel convertors are input to a face renderer unit 220 which regenerates from them the shape normalised colour level vectors of the first embodiment. These are then passed to the shape warper 158 where they are warped to take into account the current shape vector xᵢ. The subsequent processing is the same as for the first embodiment and will not, therefore, be described again.

One of the most computationally intensive operations in generating the video image from the appearance parameters is the transformation of the colour parameters into the RGB level vectors. An embodiment will now be described in which the colour level vectors are not recalculated every frame but are calculated instead every second or third frame. This alternative embodiment is described for the player unit 53 shown in FIG. 15 although it could be used in the player unit of the first embodiment. As shown, in this embodiment, the player unit 53 further comprises a control unit 223 which is operable to output a common enable signal on the control line 225 which is input to each of the parameter to pixel converters 211, 213 and 215. In this embodiment, these converters are only operable to convert the received colour parameters into corresponding RGB level vectors when enabled to do so by the control unit 223.

In operation, the parameter converter 150 outputs sets of colour parameters and a shape vector for each frame of the video sequence to be output to the display 55. The shap vector is output to the shape warper 158 as before and the respective colour parameters are output to the corresponding parameter to pixel converter. However, in this embodiment, the control unit 223 only enables the converters 211, 213 and 215 to generate the appropriate RGB level vectors for every third video frame. For video frames for which the parameter to pixel converters 211, 213 and 215 have not been enabled, the face renderer 220 is operable to output the RGB level vectors generated for the previous frame which are then warped with the new shape vector for the current video frame by the shape warper 158.

As a further alternative, rather than recalculating the colour level vectors once every second or third video frame, the colour level vectors could be calculated whenever the corresponding input parameters have changed by a predetermined amount. This is particularly useful in the embodiment which uses a separate model for the eyes and mouth and the rest of the face since only the colour corresponding to the specific component need be updated. Such an embodiment would be achieved by providing the control unit 223 with the parameters output by the parameter converter 150 so that it can monitor the change between the parameter values from one frame to the next. Whenever this change exceeds a predetermined threshold, the appropriate parameter to pixel converter would be enabled by a dedicated enable signal from the control unit to that converter. The face renderer 220 would then be operable to combine the new RGB level vectors for that component with the old RGB level vectors for the other components to generate the shape normalised RGB level vectors for the face which are then input to the shape warper 158.

As mentioned above, one of the most computationally intensive operations of this system is the conversion of the colour appearance parameters into colour level vectors. Sometimes, with low powered devices such as mobile telephones, the amount of processing power available at each time point will vary. In this case, the number of colour modes of variation (i.e. the number of colour parameters) used to reconstruct the colour level vector may be dynamically varied depending on the processing power currently available. For example, if the mobile telephone receives thirty colour parameters for each frame, then when all of the processing power is available, it might use all of those thirty parameters to reconstruct the colour level vectors. However, if the available processing power is reduced, then only the first twenty colour parameters (representing the most significant colour modes of variation) would be used to reconstruct the colour level vectors.

FIG. 16 is a block diagram illustrating the form of a player unit 53 which is programmed to operate in the above way. In particular, the parameter converter 150 is operable to receive the input appearance parameters and to generate the shape vector xⁱ and the red, green and blue colour parameters (pᵣⁱ, p_{g}ⁱ and p_{b}ⁱ) which it outputs to the parameter to pixel converter 226. The parameter to pixel converter 226 then uses equations (6) to convert those colour parameters into corresponding red, green and blue level vectors. In this embodiment, the control unit 223 is operable to output a control signal 228 depending on the current processing power available to the converter unit 226. Depending on the level of the control signal 228, the parameter to pixel converter 226 dynamically selects the number of colour parameters that it uses in the equations (6). As those skilled in the art will appreciate, the dimensions of the colour model matrixes (Q) are not changed but some of the elements in the colour parameters (pᵣⁱ, p_{g}ⁱ and p_{b}ⁱ) are set to zero. In this embodiment, the colour parameters relating to the least significant modes of variation are the parameter values set to zero, since these will have the least effect on the pixel values.

In the above embodiments, the encoded speech and appearance parameters were received by each phone, decoded and then output to the user. In an alternative embodiment, the phone may include a store for caching animation and audio sequences in addition to the appearance model. This cache may then be used to store predetermined or “canned” animation sequences. These predetermined animation sequences can then be played to the user upon receipt of an appropriate instruction from the other party to the communication. In this way, if an animation sequence is to be played repeatedly to the user, then the appearance parameters for the sequence only need to be transmitted to the user once.

The above embodiments have described a number of different two-way telecommunication systems. As those skilled in the art will appreciate, the above animation techniques may be used in a similar way for leaving messages for users. For example, a user may record a message which may be stored in the central server until retrieved by the called party. In this case, the message may include the corresponding sequence of appearance parameters together with the encoded audio. Alternatively, the appearance parameters for the video animation may be generated either by the server or by the called party's telephone at the time that the called party retrieves the message. The messaging may use pre-recorded canned sequences either of the user or of some arbitrary real or fictional character. In selecting a canned sequence, the user may use an interface that allows them to browse the selection of canned sequences that are available on a server and view them on his/her phone before sending the message. As a further alternative, when the user initially registers for the service and uses the photo booth, the photo booth may ask the user if he wants to record an animation and speech for any prepared phrases for later use as pre-recorded messages. In such a case, the user may be presented with a selection of phrases from which they may choose one or more. Alternatively, the user may record their own personal phrases. This would be particularly appropriate for a text to video messaging system since it will provide a higher quality animation compared to when text only is used to drive the video sequence.

In the above embodiments, the appearance models that were used were generated from a principle component analysis of a set of training images. As those skilled in the art will appreciate, these results apply to any model which can be parameterised by a set of continuous variables. For example, vector quantisation and wavelet techniques can be used.

In the above embodiments, the shape parameters and the colour parameters were combined to generate the appearance parameters. This is not essential. Separate shape and colour parameters may be used. Further, if the training images are black and white, then the texture parameters may represent the grey level in the images rather then the red, green and blue levels. Further, instead of modelling red, green and blue values, the colour may be represented by chrominance and luminance components or by hue, saturation and value components.

In the above embodiments, the models used were 2-dimensional models. If sufficient processing power is available within the portable devices, 3D models could be used. In such an embodiment, the shape model would model a 3-dimensional mesh of landmarks points over the training models. The 3-dimensional training examples may be obtained using a 3-dimensional scanner or by using one or more stereo pairs of cameras.

In the above embodiments, the appearance models that were used generated video images of the respective user. This is not essential. Each user may, for example, chose an appearance model that is representative of a computer generated character, which may be both a human or a non-human character. In this case, the service provider may store the appearance models for a number of different characters from which each subscriber can select a character that they wish to use. Alternatively still, the called party may choose the identity or character used to animate the caller. The chosen identity may be one of a number of different models of the caller or a model of some other real or fictional character.

In the above embodiments, it is assumed that the mobile phone does not have the relevant appearance model to generate the animation sequence of the other party. However, in some embodiments, each mobile phone may store a number of different user's appearance models so that they do not have to be transmitted over the telephone network. In this case, only the animation parameters need to be transmitted over the telephone network. In such an embodiment, the telephone network would send a request to the mobile telephone to ask if it has the appropriate appearance model for the other party to the call, and is only operable to send the appropriate appearance model if it does not have it. Further, since with current mobile telephone networks, there is an overhead of approximately five seconds in setting up a connection to send a file, if the model is required as well as the parameter stream, it is better to send both of these in one file. Hence in a preferred embodiment the server stores two versions of each animation file ready for sending, one having the model and one without.

In the first embodiment described above, appearance parameters for the caller were transmitted to the called party and vice versa. The caller's phone and the called party's phone then used the received appearance parameters to generate a video sequence for the respective user. In an alternative embodiment, the player may be adapted to switch between showing the video of the called party and the caller depending on who is speaking. Such an embodiment is particularly suitable for systems which generate the video sequence directly from the speech since it is (i) difficult to animate the called party appropriately when they are not talking; and (ii) the user may want to see the video of himself being generated in order to verify its credibility.

In the above embodiments, the subscriber telephones were described as being mobile telephones. As those skilled in the art will appreciate, the landline telephones shown in FIG. 1 can also be adapted to operate in the same way. In this case, the local exchange connected to the landlines would have to interface the landline telephones as appropriate with the service provider server.

In the above mbodiments, a photo booth was provided for the user to provide images to the server so that an appropriate appearance model could be generated for use with the system. As those skilled in the art will appreciate, other techniques can be used to input the images of the user for generating the appearance model. For example, the appearance model builder software which is provided in the above embodiments in the server could be provided on the user's home computer. In such a case, the user can directly generate their own appearance model from images that the user inputs either from a scanner or from a digital still or video camera. Alternatively still, the user may simply send photographs or digital images to a third party who can then use them to construct the appearance model for use in the system.

A number of embodiments have been described above which are based around a telephone system. Many of the features of the embodiments described above can be used in other applications. For example, the player units described with reference to FIGS. 14, 15 and 16 could advantageously be used in any hand-held device or in a device in which there is limited processing power available. Similarly, the embodiments described above in which a video sequence is generated directly from the speech of a user, could be used to locally generate the video sequence rather than transmitting it to another user. Further, many of the modifications and alternative embodiments described above can be used in communications over the internet, where limited bandwidth is available between, for example, a user terminal and a server on the internet.

1. A telephone for use with a telephone network, the telephone comprising:
a memory for storing model data that defines a function which relates one or more parameters of a set of parameters to texture data defining a shape normalised appearance of an object and which relates one or more parameters of the set of parameters to shape data defining a shape for the object;
means for receiving a plurality of sets of parameters representing a video sequence;
means for generating texture data defining the shape normalised appearance of the object for at least one set of received parameters and for generating shape data for the object for a plurality of sets of received parameters;
means for warping generated texture data with generated shape data to generate image data defining the appearance of the object in a frame of the video sequence; and
a display driver for driving a display to output the generated image data to synthesise the video sequence.

2. A telephone according to claim 1, wherein the shape data generated from a set of parameters comprises a set of locations which identify the relative positions of a plurality of predetermined points on the object in the video frame corresponding to the received set of parameters.

3. A telephone according to claim 2, wherein said warping means is operable to identify the locations of said plurality of predetermined points on the object within said texture data representative of the shape normalised object and is operable to warp the texture data so that the determined locations of said predetermined points are warped to the locations of the corresponding points defined by said shape data.

4. An apparatus according to any preceding claim, wherein said generating means is operable to generate texture data defining the shape normalised appearance of the object and shape data for the object for each set of received parameters and wherein said warping means is operable to warp the generated texture data for each set of parameters with the corresponding shape data generated from the set of parameters.

5. An apparatus according to any of claims 1 to 3, wherein said generating means is operable to generate texture data for selected sets of said received parameters and wherein said warping means is operable to warp texture data for a previous set of parameters with shape data for a current set of received parameters in the event that said generating means does not generate texture data for a current set of received parameters.

6. A telephone according to claim 5 comprising selecting means for selecting sets of parameters from said received plurality of sets of parameters for which said generating means will generate texture data.

7. A telephone according to claim 6, wherein said selecting means is operable to select sets of parameters from the received plurality of sets of parameters in accordance with predetermined rules.

8. A telephone according to claim 6 to 7, comprising means for comparing parameter values from a current set of parameters with parameter values of a previous set of parameters and wherein said selecting means is operable to select said current set of parameters in dependence upon the result of said comparison.

9. A telephone according to claim 8, wherein said selecting means is operable to select said current set of parameters if one or more of said parameters of said current set differ from the corresponding parameter value of the previous set by more than a predetermined threshold.

10. A telephone according to any of claims 6 to 9, wherein said selecting means is operable to select the sets of parameters for which said generating means will generate said texture data in dependence upon an available processing power of the telephone.

11. A telephone according to claim 10, wherein each parameter represents a mode of variation of the texture for the object and wherein said selecting means is operable to select as many of the most significant modes of variation which can be converted to texture data with the available processing power is substantially real time.

12. An apparatus according to any of claims 1 to 3, comprising means for comparing parameter values from a current set of parameters with parameter values of a previous set of parameters and wherein said warping means is operable to warp texture data for the N parameter values that have changed the most.

13. A telephone according to claim 12, wherein N is determined in dependence upon the available processing power.

14. A telephone according to claim 12 or 13, wherein said generating means is operable to generate shape normalised textured data by updating the shape normalised texture data for the previous set of parameters with the determined difference of those N parameters.

15. A telephone according to any preceding claim, wherein said model data comprises first model data which relates a set of received parameters into a set of intermediate shape parameters and a set of intermediate texture parameters; wherein the model data further comprises second model data which defines a function which relates the intermediate shape parameters to said shape data; wherein the model data further comprises third model data which defines a function which relates the set of intermediate texture parameters into said texture data; and wherein said generating means comprises means for generating a set of intermediate shape and texture parameters using the first model data for each set of received parameters transmitted from the telephone network using the first model data.

16. A telephone according to any preceding claim, wherein said receiving means is operable to receive said model data from the telephone network and further comprising means for storing said received model data in said memory.

17. A telephone according to claim 16, wherein said received model data is encoded and further comprising means for decoding the model data.

18. A telephone according to claim 17, wherein the model data is encoded by applying predetermined sets of parameters to the model data to derive corresponding texture data for each of the predetermined sets of target parameters and by compressing the thus determined texture data generated from the sets of parameters; and wherein said decoder comprises means for decompressing said compressed texture data and means for resynthesising said model data using said decompressed texture data and the predetermined sets of parameters.

19. A telephone according to any preceding claim, further comprising means for receiving audio signals associated with the video sequence and means for outputting the audio signals to a user in synchronism with the video sequence.

20. A telephone according to claim 19, wherein said audio signals and said sets of parameters are interleaved with each other.

21. A telephone according to any preceding claim, comprising means for receiving speech and means for processing speech to generate said plurality of sets of parameters representing said video sequence and wherein said receiving means is operable to receive said parameters from said speech processing means.

22. A telephone according to claim 21, wherein said speech processing means comprises a speech recognition unit for converting the received speech into a sequence of sub-word units and means for converting said sequence of sub-word units into said plurality of sets of parameters representing said video sequence.

23. A telephone according to claim 22, wherein said converting means comprises a look-up table for converting each sub-word unit into a corresponding set of parameters representing a frame of said video sequence.

24. A telephone according to claim 23, wherein said converting means comprises a plurality of look-up tables each associated with a different emotional state of the object and further comprising means for selecting one of the look-up tables for performing said conversion in dependence upon a detected emotional state of the object.

25. A telephone according to claim 24, wherein said processing means is operable to process said speech in order to determine the emotional state of the object and is operable to select the corresponding look-up table to be used by said converting means.

26. A telephone according to any of claims 1 to 18, comprising means for receiving text and means for processing the received text to generate sets of parameters representing a video sequence corresponding to the object speaking the text and wherein said receiving means is operable to receive said plurality of sets of parameters from said text processing means.

27. A telephone according to claim 26, further comprising a text to speech synthesiser for synthesising speech corresponding to the text and means for outputting the synthesised speech in synchronism with the corresponding video sequence.

28. A telephone according to claim 26 or 27, wherein said text processing means comprises means for converting the received text into a sequence of sub-word units and means for converting the sequence of sub-word units into said plurality of sets of parameters.

29. A telephone according to any preceding claim, further comprising a memory for storing sets of parameters representing a predetermined video sequence and further comprising means for receiving a trigger signal in response to which said generating means is operable to generate texture data and shape data for the stored plurality of sets of parameters.

30. A telephone according to any preceding claim, further comprising means for storing transformation data defining a transformation from a set of received parameters to a set of transformed parameters and means for altering the appearance of the object in a frame using said transformation data.

31. A telephone according to any preceding claim, further comprising:
a second memory for storing second model data that defines a function which relates image data of a second object to a set of parameters;
means for receiving image data for the second object;
means for determining a set of parameters for the second object using the image data and the second model data; and
means for transmitting the determined set of parameters for the second object to said telephone network.

32. A telephone according to claim 31, wherein said image data receiving means is operable to receive image data corresponding to a video sequence, wherein said parameter determining means is operable to determine a plurality of sets of parameters for the second object in the video sequence and wherein said transmitting means is operable to transmit said plurality of sets of parameters for the second object to said telephone network.

33. A telephone according to claim 31 or 32, further comprising means for sensing light from the second object and for generating said image data therefrom.

34. A telephone according to any of claims 31 to 33, wherein said transmitting means is operable to transmit said second model data to the telephone network for transmission to a calling party or to a party to be called.

35. A telephone according to any of claims 1 to 30, comprising a microphone for receiving speech from a user; means for processing the received speech to generate a set of parameters representative of the appearance of the user and means for transmitting the parameters representative of the appearance of the user to the telephone network.

36. A telephone according to claim 35, wherein said processing means comprises an automatic speech recognition unit for converting the user's speech into a sequence of sub-word units and means for converting the sequence of sub-word units into said set of parameters representative of the appearance of the user.

37. A telephone according to claim 36, wherein said converting means comprises a look-up table for converting each sub-word unit into a corresponding set of parameters representing the appearance of the user whilst pronouncing the corresponding sub-word unit.

38. A telephone according to any of claims 1 to 34, further comprising means for receiving text from a user, means for processing the received text to generate sets of parameters representing the appearance of the user speaking the text and means for transmitting the parameters representative of the appearance of the user to the telephone network.

39. A telephone according to claim 38, wherein said text processing means comprises first converting means for converting the received text into a sequence of sub-word units and second converting means for converting the sequence of sub-word units into said plurality of sets of parameters.

40. A telephone according to any preceding claim, wherein said texture data defines the shape normalised colour appearance of the object.

41. A telephone according to claim 40, wherein said texture data comprises separate red texture data, green texture data and blue texture data.

42. A telephone according to any preceding claim, wherein said object is a face representing a party to a call.

43. A telephone according to claim 42, wherein said generating means is operable to generate separate texture data for the eyes of the face, the mouth of the face and for the remainder of the face region.

44. A telephone according to claim 38, wherein each set of parameters comprises a respective subset of parameters each subset being associated with one of the eyes of the face, the mouth of the face and the remainder of the face region.

45. A telephone according to claim 43 or 44, wherein said texture data for the remainder of the face region is a constant texture.

46. A telephone for use with a telephone network, the telephone comprising:
means for receiving a speech signal from a user;
means for processing the received speech signal to generate a plurality of sets of parameters representative of the appearance of the user speaking said speech; and
means for transmitting the parameters representative of the appearance of the user to the telephone network.

47. A telephone according to claim 46, wherein said processing means comprises an automatic speech recognition unit for converting the user's speech into a sequence of sub-word units and means for converting the sequence of sub-word units into said sets of parameters representative of the appearance of the user.

48. A telephone according to claim 47, wherein said converting means comprises a look-up table for converting each sub-word unit into a corresponding set of parameters representing the appearance of the user whilst pronouncing the corresponding sub-word unit.

49. A telephone according to claim 48, wherein said converting means comprises a plurality of look-up tables and wherein said speech processing means is operable to determine a mood of the user from said received speech signal and is operable to select a look-up table for use by said converting means.

50. A telephone for use with a telephone network, the telephone comprising:
means for receiving text from a user;
means for processing the received text to generate a plurality of sets of parameters representing the appearance of the user speaking the text; and
means for transmitting the parameters representative of the appearance of the user to the telephone network.

51. A telephone according to claim 50, wherein said text processing means comprises first converting means for converting the received text into a sequence of sub-word units and second converting means for converting the sequence of sub-word units into said plurality of sets of parameters.

52. A telephone according to claim 51, wherein said second converting means comprises a look-up table for converting each sub-word unit into a corresponding set of parameters representing the appearance of the user whilst pronouncing the corresponding sub-word unit.

53. A telephone according to claim 52, wherein said second converting means comprises a plurality of look-up tables each associated with a respective different mood of the user; and further comprising means for sensing a current mood of the user and for selecting a corresponding look-up table for use by said converting means.

54. A GSM telephone for use with a GSM network, the GSM telephone comprising:
a GSM audio codec for encoding audio data;
means for receiving audio data and video data;
means for mixing the audio data and the video data to generate a mixed stream of audio and video data;
means for encoding the mixed stream of audio and video data using said audio codec; and
means for transmitting said encoded audio and video data to said telephone network.

55. A telephone network server for controlling a communication link between first and second subscriber telephones, said telephone network server comprising:
a memory for storing model data for the first subscriber that defines a function which relates one or more parameters of a set of parameters to texture data defining a shape normalised appearance of an object associated with the first subscriber and which relates one or more parameters of the set of parameters to shape data defining a shape for the object associated with the first subscriber;
means for receiving a signal indicating that a call is being initiated between said first and second subscribers; and
means responsive to said signal for transmitting said model data for said first subscriber to the second subscriber's telephone.

56. A telephone network server according to claim 55, wherein said memory further comprises model data for said second subscriber and wherein said transmitting means is operable to transmit the model data for said second subscriber to the telephone of said first subscriber.

57. A telephone network server according to claim 55 or 56, further comprising means for generating a plurality of sets of parameters representing a video sequence from which a video sequence can be synthesised using said model data and means for transmitting said sets of parameters to said first or second subscriber's telephone.

58. A telephone network server according to claim 57, wherein said generating means is operable to generate said plurality of sets of parameters from a speech signal received from said first subscriber's telephone.

59. A telephone network server according to claim 58, further comprising an automatic speech recognition unit for processing said received speech signal and for generating a sequence of sub-word units representative of the received speech and means for converting said sequence of sub-word units into said plurality of sets of parameters.

60. A telephone network server according to claim 56, wherein said generating means comprises means for receiving text from the first subscriber's telephone, first converting means for converting the received text into a sequence of sub-word units; and second converting means for converting the sequence of sub-word units into said plurality of sets of parameters.

61. A telephone network server according to claim 59 or 60, wherein said converting means comprises a look-up table relating each sub-word unit to a corresponding set of parameters.

62. A telephone network comprising a telephone network server according to any of claims 55 to 61 and a plurality of telephones according to any of claims 1 to 54.

63. An apparatus for synthesising a video sequence, comprising:
a memory for storing model data that defines a function which relates one or more parameters of a set of parameters to texture data defining a shape normalised appearance of an object and which relates one or more parameters of the set of parameters to shape data defining a shape for the object;
means for receiving a plurality of sets of parameters representing a video sequence;
means for generating texture data defining the shape normalised appearance of the object for at least one set of received parameters and for generating shape data for the object for a plurality of sets of received parameters;
means for warping generated texture data with generated shape data to generate image data defining the appearance of the object in a frame of the video sequence; and
a display driver for driving a display to output the generated image data to synthesise the video sequence.

64. An apparatus according to claim 63, wherein said generating means is operable to generate texture data for selected sets of said received parameters and wherein said warping means is operable to warp texture data for a previous set of parameters with shape data for a current set of received parameters in the event that said generating means does not generate texture data for a current set of received parameters.

65. An apparatus according to claim 64, comprising selecting means for selecting sets of parameters from said received plurality of sets of parameters for which said generating means will generate texture data.

66. An apparatus according to claim 65, wherein said selecting means is operable to select sets of parameters from the received plurality of sets of parameters in accordance with predetermined rules.

67. An apparatus according to claim 65 or 66, comprising means for comparing parameter values from a current set of parameters with parameter values of a previous set of parameters and wherein said selecting means is operable to select said current set of parameters in dependence upon the result of said comparison.

68. An apparatus according to claim 67, wherein said selecting means is operable to select said current set of parameters if one or more of said parameters of said current set differ from the corresponding parameter value of the previous set by more than a predetermined threshold.

69. An apparatus according to any of claims 65 to 68, wherein said selecting means is operable to select the sets of parameters for which said generating means will generate said texture data in dependence upon an available processing power of the apparatus.

70. An apparatus according to any of claims 63 to 69, wherein said model data comprises first model data which relates a set of received parameters into a set of intermediate shape parameters and a set of intermediate texture parameters; wherein the model data further comprises second model data which defines a function which relates the intermediate shape parameters to said shape data; wherein the model data further comprises third model data which defines a function which relates the set of intermediate texture parameters into said texture data; and wherein said generating means comprises means for generating a set of intermediate shape and texture parameters using the first model data for each set of received parameters.

71. An apparatus according to any of claims 63 to 70, further comprising means for receiving audio signals associated with the video sequence and means for outputting the audio signals to a user in synchronism with the video sequence.

72. An apparatus according to any of claims 63 to 71, comprising means for receiving speech and means for processing the received speech to generate said plurality of sets of parameters repres nting said video sequence and wherein said receiving means is operable to receive said parameters from said speech processing means.

73. An apparatus according to claim 72, wherein said speech processing means comprises a speech recognition unit for converting the received speech into a sequence of sub-word units and means for converting said sequence of sub-word units into said plurality of sets of parameters representing said video sequence.

74. An apparatus according to claim 73, wherein said converting means comprises a look-up table for converting each sub-word unit into a corresponding set of parameters representing a frame of said video sequence.

75. An apparatus according to claim 73, wherein said converting means comprises a plurality of look-up tables each associated with a different emotional state of the object and further comprising means for selecting one of said look-up tables for use by said converting means in dependence upon a detected emotional state of the object.

76. An apparatus according to claim 75, wherein said speech recognition unit is operable to detect the emotional state of the object from said speech signal.

77. An apparatus according to any of claims 63 to 71, comprising means for receiving text and means for processing the received text to generate sets of parameters representing a video sequence corresponding to the object speaking the text, wherein said receiving means is operable to receive said plurality of sets of parameters from said text processing means.

78. An apparatus according to claim 77, further comprising a text-to-speech synthesiser for synthesising speech corresponding to the text and means for outputting the synthesised speech in synchronism with the corresponding video sequence.

79. An apparatus according to claim 77 or 78, wherein said text processing means comprises first converting means for converting the received text into a sequence of sub-word units and second converting means for converting the sequence of sub-word units into said plurality of sets of parameters.

80. An apparatus according to claim 79, wherein said second converting means comprises a look-up table for converting each sub-word unit into a corresponding set of parameters representing a frame of said video sequence.

81. An apparatus according to claim 80, wherein said second converting means comprises a plurality of look-up tables and further comprising means for selecting one of said look-up tables for use by said second converting means.

82. A computer readable medium storing computer executable process steps for causing a programmable computer device to become configured as a telephone according to any of claims 1 to 54, a telephone network server according to any of claims 55 to 62 or an apparatus according to any of claims 63 to 81.

83. Computer implementable instructions for causing a programmable processor to become configured as a telephone according to any of claims 1 to 54, a telephone network server according to any of claims 55 to 62 or an apparatus according to any of claims 63 to 81.
